(19) United States
(12) Patent Application Publication
(10) Pub. No.: US 2025/0173179 A1
(43) Pub. Date: May 29, 2025

(54) SYSTEM AND METHOD FOR DYNAMIC TASK MANAGEMENT ACROSS A NETWORK

(71) Applicant: BANK OF AMERICA CORPORATION, Charlotte, NC (US)

(72) Inventors: Heidi L. Cooper, Austin, TX (US); Sushil Kumar Sahoo, Charlotte, NC (US); Levi Jennings, Dallas, TX (US); Siddhartha Shankar Nayak, Chennai (IN); Satya Pandey, Uttar Pradesh (IN); Niranian Babu Yeranagula, Charlotte, NC (US)

(73) Assignee: BANK OF AMERICA CORPORATION, Charlotte, NC (US)

(21) Appl. No.: 18/521,101

(22) Filed: Nov. 28, 2023

(51) Int. Cl. G06F 9/48; H04L 67/10

(52) U.S. Cl. CPC G06F 9/4881; H04L 67/10

(57) ABSTRACT

Systems, computer program products, and methods are described herein for dynamic task management across a network. The method includes receiving a task to be completed by one or more end-point devices. The method also includes determining one or more task actions that are part of the task. The method further includes receiving a task action input indicating a change to at least one of the one or more task actions or an additional task action to be added to the one or more task actions. The method still further includes updating the one or more task actions based on the task action input. The method also includes determining a task action order for each of the one or more task actions. The method further includes assigning at least one of the task actions to at least one of the end-point devices on the network based on the task action order.

### TECHNOLOGICAL FIELD

Example embodiments of the present disclosure relate generally to task management across a network and, more particularly, to dynamic task management across a network.

### BACKGROUND

To facilitate advanced analytics and reporting, there is a need to integrate workflow automation platform architectures case and workflow historical data into a comprehensive reporting platform. However, such an integrated workflow automation platform with many different processing paths make creating and/or updating new tasks difficult without unnecessary time delays and/or strain on processing capabilities. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for dynamic task management across a network is provided. The system includes at least one non-transitory storage device containing instructions and at least one processing device coupled to the at least one non-transitory storage device. The at least one processing device, upon execution of the instructions, is configured to receive a task, including metadata relating to the task, to be completed by one or more end-point devices on a network. The at least one processing device, upon execution of the instructions, is also configured to determine one or more task actions that are part of the task based on the metadata relating to the task. Each of the one or more task actions are completed by one of the one or more end-point devices on the network. The at least one processing device, upon execution of the instructions, is further configured to receive a task action input. The task action input indicates a change to at least one of the one or more task actions or indicates an additional task action to be added to the one or more task actions. The at least one processing device, upon execution of the instructions, is still further configured to update the one or more task actions based on the task action input. The at least one processing device, upon execution of the instructions, is also configured to determine a task action order for each of the one or more task actions. The task action order indicates one or more of the task actions that must be completed before a given task action order can be started. The at least one processing device, upon execution of the instructions, is further configured to assign at least one of the one or more task actions to at least one of the one or more end-point devices on the network based on the task action order.

In various embodiments, the at least one processing device, upon execution of the instructions, is also configured to cause a user interface to be rendered to at least one of the one or more end-point devices on the network with the user interface including each of the task actions assigned to the given end-point device.

In various embodiments, the user interface rendered to at least one of the one or more end-point devices includes a plurality of assigned task actions assigned to the given end-point device and the plurality of assigned task actions includes at least one of the one or more task actions associated with the task and at least one additional task action associated with one or more additional tasks.

In various embodiments, the at least one processing device, upon execution of the instructions, is also configured to receive an additional task to be completed by the one or more end-point devices on the network and determine one or more additional task actions based on the one or more task actions associated with the task.

In various embodiments, the at least one processing device, upon execution of the instructions, is also configured to cause a user interface to be rendered to at least one of the one or more end-point devices on the network with the user interface including at least one of the one or more task actions and at least one of the one or more additional task actions assigned to the given end-point device.

In various embodiments, the assignment of the at least one of the one or more task actions includes determining a task permission for each of the at least one of the one or more task actions.

In various embodiments, the at least one processing device, upon execution of the instructions, is also configured to assign a primary end-point device of the one or more end-point devices on the network for the task with the primary end-point device being capable of providing a task action input.

In various embodiments, the at least one processing device, upon execution of the instructions, is also configured to cause a notification to be transmitted to at least one of the one or more end-point devices in an instance in which one of the one or more task actions is assigned and in an instance in which the one of the one or more task actions is completed.

In various embodiments, the at least one processing device, upon execution of the instructions, is also configured to determine an assignment for one of the one or more end-point devices based upon one of the one or more task actions completed by the given end-point device.

In another example embodiment, a computer program product for dynamic task management across a network is provided. The computer program product includes at least one non-transitory computer-readable medium having computer-readable program code portions embodied therein. The computer-readable program code portions include one or more executable portions configured to receive a task, including metadata relating to the task, to be completed by one or more end-point devices on a network. The computer-readable program code portions include one or more executable portions also configured to determine one or more task actions that are part of the task based on the metadata relating to the task. Each of the one or more task actions are completed by one of the one or more end-point devices on the network. The computer-readable program code portions include one or more executable portions further configured to receive a task action input. The task action input indicates a change to at least one of the one or more task actions or indicates an additional task action to be added to the one or more task actions. The computer-readable program code portions include one or more executable portions still further configured to update the one or more task actions based on the task action input. The computer-readable program code portions include one or more executable portions also configured to determine a task action order for each of the one or more task actions. The task action order indicates one or more of the task actions that must be completed before a given task action order can be started. The computer-readable program code portions include one or more executable portions further configured to assign at least one of the one or more task actions to at least one of the one or more end-point devices on the network based on the task action order.

In various embodiments, the computer-readable program code portions comprising one or more executable portions are also configured to cause a user interface to be rendered to at least one of the one or more end-point devices on the network with the user interface including each of the task actions assigned to the given end-point device, the user interface rendered to at least one of the one or more end-point devices including a plurality of assigned task actions assigned to the given end-point device, and the plurality of assigned task actions including at least one of the one or more task actions associated with the task and at least one additional task action associated with one or more additional tasks.

In various embodiments, the computer-readable program code portions comprising one or more executable portions are also configured to receive an additional task to be completed by the one or more end-point devices on the network; determine one or more additional task actions based on the one or more task actions associated with the task; and cause a user interface to be rendered to at least one of the one or more end-point devices on the network with the user interface including at least one of the one or more task actions and at least one of the one or more additional task actions assigned to the given end-point device.

In various embodiments, the assignment of the at least one of the one or more task actions comprises determining a task permission for each of the at least one of the one or more task actions.

In various embodiments, the computer-readable program code portions comprising one or more executable portions are also configured to assign a primary end-point device of the one or more end-point devices on the network with the primary end-point device being capable of providing a task action input.

In various embodiments, the computer-readable program code portions comprising one or more executable portions are also configured to cause a notification to be transmitted to at least one of the one or more end-point devices in an instance in which one of the one or more task actions is assigned and in an instance in which the one of the one or more task actions is completed.

In still another example embodiment, a method for dynamic task management across a network is provided. The method includes receiving a task, including metadata relating to the task, to be completed by one or more end-point devices on a network. The method also includes determining one or more task actions that are part of the task based on the metadata relating to the task. Each of the one or more task actions are completed by one of the one or more end-point devices on the network. The method further includes receiving a task action input. The task action input indicates a change to at least one of the one or more task actions or indicates an additional task action to be added to the one or more task actions. The method still further includes updating the one or more task actions based on the task action input. The method also includes determining a task action order for each of the one or more task actions. The task action order indicates one or more of the task actions that must be completed before a given task action order can be started. The method further includes assigning at least one of the one or more task actions to at least one of the one or more end-point devices on the network based on the task action order.

In various embodiments, the method includes causing a user interface to be rendered to at least one of the one or more end-point devices on the network. In such an embodiment, the user interface includes each of the task actions assigned to the given end-point device, the user interface rendered to at least one of the one or more end-point devices includes a plurality of assigned task actions assigned to the given end-point device, and the plurality of assigned task actions includes at least one of the one or more task actions associated with the task and at least one additional task action associated with one or more additional tasks.

In various embodiments, the method includes receiving an additional task to be completed by the one or more end-point devices on the network; determining one or more additional task actions based on the one or more task actions associated with the task; and causing a user interface to be rendered to at least one of the one or more end-point devices on the network. The user interface includes at least one of the one or more task actions and at least one of the one or more additional task actions assigned to the given end-point device.

In various embodiments, the method includes assigning a primary end-point device of the one or more end-point devices on the network with the primary end-point device being capable of providing a task action input.

In various embodiments, the method includes causing a notification to be transmitted to at least one of the one or more end-point devices in an instance in which one of the one or more task actions is assigned and in an instance in which the one of the one or more task actions is completed.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an example distributed computing environment for dynamic task management across a network, in accordance with various embodiments of the present disclosure;

FIG. 2 illustrates an example machine learning (ML) subsystem architecture 200 used in accordance with various embodiments of the present disclosure; and

FIGS. 3A and 3B illustrate a process flow for dynamic task management across a network, in accordance with various embodiments of the present disclosure;

FIG. 4 illustrates a process flow for extraction of historical data in workflow automation platform architectures, in accordance with various embodiments of the present disclosure; and

FIG. 5 illustrates a process flow for parallel processing data extraction of historical data in workflow automation platform architectures, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, a “workflow automation platform” may refer to a system or software framework that facilitates the design, execution, and management of various interrelated tasks within an entity or organizational process. This platform typically integrates multiple tasks, tools, and systems into a cohesive flow, ensuring that interactions between tasks are seamless and efficient. It can monitor, control, and optimize user interactions and system operations, ensuring that tasks are executed in the correct sequence and that any dependencies are adequately addressed. Such platforms might also incorporate features for tracking, analyzing, and reporting on the performance of workflows, providing valuable insights for continuous improvement. Moreover, it may cater to both human-to-human, human-to-machine, and machine-to-machine interactions, ensuring a holistic approach to automation within an organization.

Furthermore, the “workflow automation platform” as referenced in this context, may include a comprehensive software suite tailored for the management and optimization of entity processes and customer relationships. This platform encompasses tools that enable entities to define, automate, and enhance operational processes through intuitive drag-and-drop functionalities, negating the need for extensive coding. The workflow automation platform may integrate customer relationship management (CRM) solutions, ensuring consistent and personalized customer interactions across all channels. In some embodiments, the platform may excel in case management, handling multifaceted transactions and customer inquiries. To augment automation, it assimilates with robotic process automation tools, mitigating repetitive tasks and human error. By use of AI and machine learning capabilities, the platform provides data-driven guidance for optimal decision-making. Furthermore, with cloud-based offerings, it ensures scalability and adaptability without the constraints of extensive on-premises infrastructure. Its agility and low-code to no-code development approach facilitate rapid application development, making it a responsive tool for ever-evolving entity needs.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “user interface” (UI) refers to the space where interactions between humans and machines occur, aiming to facilitate an effective operation and control of a machine from the user end. This interface may encompass both the tangible elements, like buttons and touchscreens of a device, and the intangible elements, like visual layout, response time, and components of the user experience. In some embodiments, the UI is the bridge that conveys a system functionality to users, ensuring users can navigate, input, and extract data seamlessly.

As used herein, “data extract configuration” may refer to the systematic process and set of parameters established for retrieving specific data from a source system, database, or application. This configuration delineates the conditions, formats, and structures under which data will be extracted, ensuring that the pulled information is relevant, accurate, and in a usable format for the receiving system or subsequent processes. It encompasses criteria such as data fields, timeframes, and conditions that filter out unnecessary or redundant data. Moreover, data extract configuration often includes settings that govern frequency (e.g., real-time, batch, or scheduled extracts, or the like), error handling procedures, and integration points for the extracted data with other systems or datasets. By defining these parameters, the entity may ensure the consistency, reliability, and efficiency of data extraction tailored to specific operational needs.

As used herein, “parallel processing” refers to a computational technique where multiple tasks or processes are executed concurrently, and in some embodiments simultaneously, to accelerate computational speed and enhance system efficiency. By dividing a larger problem into smaller, independent tasks, parallel processing may enable different parts of a program, or different programs altogether, to be executed at the same time. Typically leveraged in systems with multiple processors or cores, this approach maximizes resource utilization, allowing for faster data processing and task execution. In environments where vast amounts of data need to be processed or complex operations are performed, parallel processing proves instrumental in reducing computational time.

As used herein, “multi-threading” denotes a specialized form of parallel processing where a single program is split into two or more concurrently executing threads. Each thread represents a separate path of execution, and they run in the shared memory space of the program. Multi-threading takes advantage of CPU cores that might otherwise be idle, enhancing the efficiency of applications, especially in situations where multiple tasks are independent and can be performed without waiting for another to complete. In some embodiments, multi-threading may be particularly beneficial in contexts such as user interfaces for data extraction from workflow automation platform architectures, where continued user interaction is necessary even as background tasks proceed, or in server applications that handle multiple requests from users.

As used herein, “proprietary format extracts” may refer to data extraction outputs that are generated and structured in a unique, specialized format exclusive to a particular software, system, or organization. Unlike standard or open formats which are universally recognized and can be accessed by various tools or systems, proprietary format extracts may be designed for specific applications and may require specialized tools or knowledge to interpret, modify, or access. This exclusivity can stem from reasons related to security, or optimization for a particular system performance. Due to a specialized nature, these extracts might present challenges in interoperability with other systems unless appropriate conversion or interface tools are deployed. As such, the present disclosure allows for a solution to this extraction issue.

As used herein, a “job scheduler node” in the context of parallel processing with multiple threads refers to a dedicated component or unit within a computational system responsible for allocating and managing the execution of tasks across multiple threads or processors. Acting as a central management entity, the job scheduler node assesses the priority, dependencies, and resources required for various tasks. It then orchestrates their execution by determining the optimal thread or processor to handle each task, ensuring maximum utilization and efficiency. In systems with multiple threads or processors, the job scheduler node plays a pivotal role in balancing the workload, preventing bottlenecks, and optimizing throughput. This orchestration ensures that tasks are executed in a synchronized manner, minimizing conflicts and maximizing the concurrent processing benefits. From a software and hardware architecture standpoint, a job scheduler node encompasses various elements. At its core, the job scheduler node requires a sophisticated algorithm that determines the sequence and assignment of tasks based on factors like priority, dependencies, required resources, and deadlines. The job scheduler node may also include a task queue, resource monitor, communication interface, and error handling and recovery mechanisms. The task queue is a structured list where tasks await assignment to specific threads or processors. The scheduler continuously monitors this queue to make assignment decisions.

The resource monitor may include a module which continuously tracks the utilization and availability of computational resources, ensuring that the system does not get overloaded and that tasks are assigned where they can be most efficiently processed. In some embodiments, the job scheduler node needs to communicate with other system components, fetch tasks, send tasks, and receive status updates. This is achieved through well-defined Application Programming Interfaces (APIs) and communication protocols via the communication interface of the node. In any scheduling environment, tasks might fail. As such the job scheduler node software, in various embodiments, can identify these failures, potentially rolling back certain operations, and rescheduling or retrying a task.

The present disclosure introduces an improved approach to historical data extraction from workflow automation platform architecture. At its core, it employs parallel processing, utilizing a multi-threaded asynchronous tool specifically designed within the workflow automation platform architecture framework. This ensures high performance and scalability, enabling easy extraction of large data volumes within designated system maintenance windows without impinging on system performance. A key highlight is its reusability; the system framework is architected as a modular component within the workflow automation platform architecture, allowing seamless integration into various applications of the same architecture without the necessity for additional coding. From a configurability standpoint, a user interface (UI) has been devised to facilitate the configuration of record extractions per system node, complemented by a bulk upload feature. Monitoring of the process has been simplified with a UI, offering insights into execution metrics such as status, durations, and other relevant data. Additionally, the system boasts an automated notification feature, where email alerts are triggered in the event of data extraction job failures. To further ensure data integrity, a reconciliation report comparing source and destination data is incorporated.

Historically, entities use specialized systems, such as workflow automation platform architectures, to manage and streamline their internal processes. These systems store vast amounts of historical data on how these processes are carried out. This data is a complex digital library of all entity activities in some cases. However, typically these libraries are stored in data formats that are not easy exported or converted to be usable by other processes outside the confines of the workflow automation platform architecture themselves. As such, when entities desire to analyze this historical data to improve their operations, there may be challenges extracting and translating this coded data into a format that is accessible and decipherable by addition programs. Additionally, tracking the export of certain data and ensuring that the data is not extracted in duplicate poses an issue, as the workflow automation platform architecture may not be designed to handle large-scale extractions or parallel extractions in an efficient manner. Thus, entities are left with invaluable insights that may be inaccessible in an unreadable format, hindering their ability to make informed decisions based on past activities.

Addressing these challenges, the solution introduces an advanced tool, specifically engineered to extract this complex data from workflow automation platform architectures. By using sophisticated parallel processing techniques, this tool can access multiple sets of data simultaneously without causing a strain on the system. Additionally, this solution offers a modular framework, and it can be easily adapted and reused for others without significant reconfiguration or coding. To ensure smooth extraction without data redundancy, the tool is equipped with a user-friendly interface that helps entities configure and monitor the extraction process, track real-time metrics, and even alert them if there are any discrepancies or failures. This approach ensures that the once locked-away historical insights can now be accessed, understood, and utilized, allowing for better-informed entity-related decisions.

What is more, the present disclosure provides a technical solution to a technical problem. As described herein, the technical problem includes the challenge of extracting and converting historical data from workflow automation platform architectures into a normalized format suitable for reporting tools and analytics, especially when these architectures store data in proprietary binary formats not readily accessible for large-scale historical analysis. The technical solution presented herein allows for efficient extraction and normalization of large-scale historical data using parallel processing and multi-threading. In particular, the implementation of a job scheduler node, adeptly designed for optimizing parallel extraction tasks from workflow automation platforms, is an improvement over existing solutions to the data extraction and normalization challenge. This solution (i) streamlines the extraction process, conserving valuable computing resources like processing power, storage, and network bandwidth, (ii) yields more accurate data extracts, reducing the potential resource wastage on error corrections, (iii) automates the extraction process, eliminating manual inefficiencies and further saving on computational resources, and (iv) ascertains the optimal allocation of resources for the task, thereby minimizing network congestion and undue strain on computational infrastructure. Moreover, this technical approach employs a precise, computer-driven methodology to undertake tasks not previously executed. In specific implementations, the solution omits redundant steps traditionally employed, leading to even greater resource conservation.

In various embodiments, the present disclosure allows for dynamic task management across a network. To do this, the system determines one or more task actions based on a task. The task actions are determined based on previous tasks that were used within the system. The task actions are assigned to end-point devices on the network. The task may have a primary end-point device that may input a task action input that modifies the task actions and/or creates new task actions. The task actions may be assigned to one or more end-point devices to be completed. A task action order may also be determined that indicates any task actions that must be started, partially completed, and/or fully completed before a given task action may be assigned. As such, the system may assign task actions to end-point device(s) on the network.

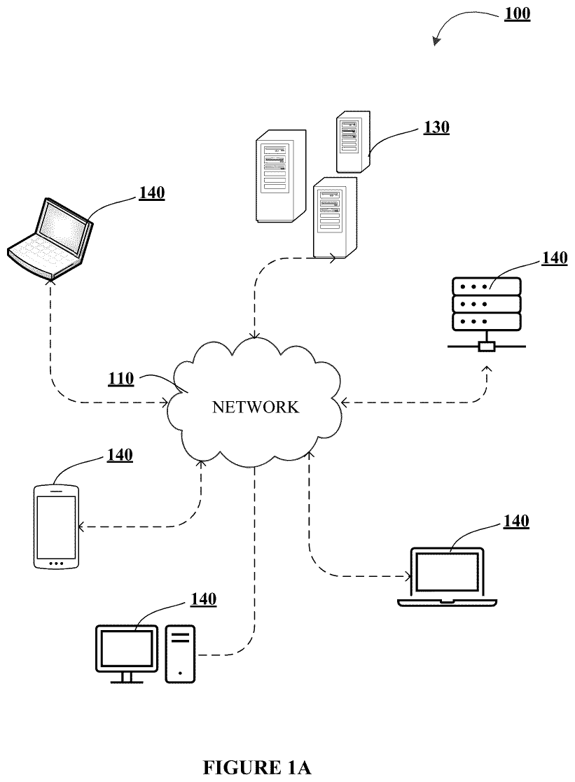

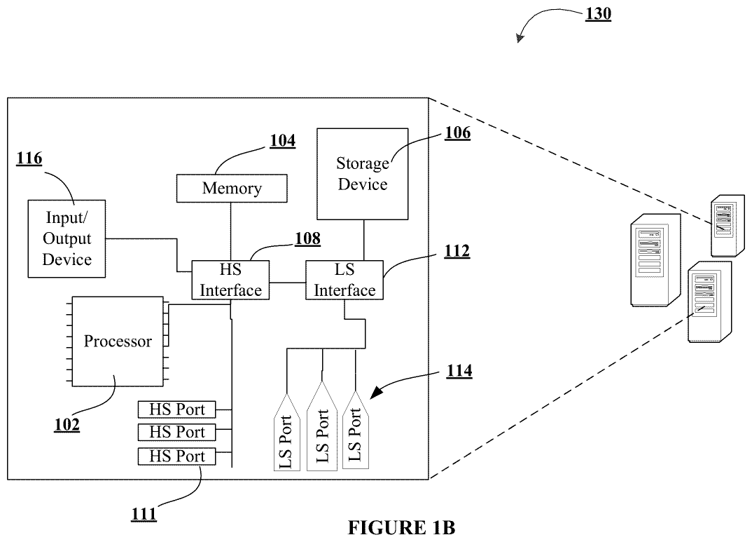

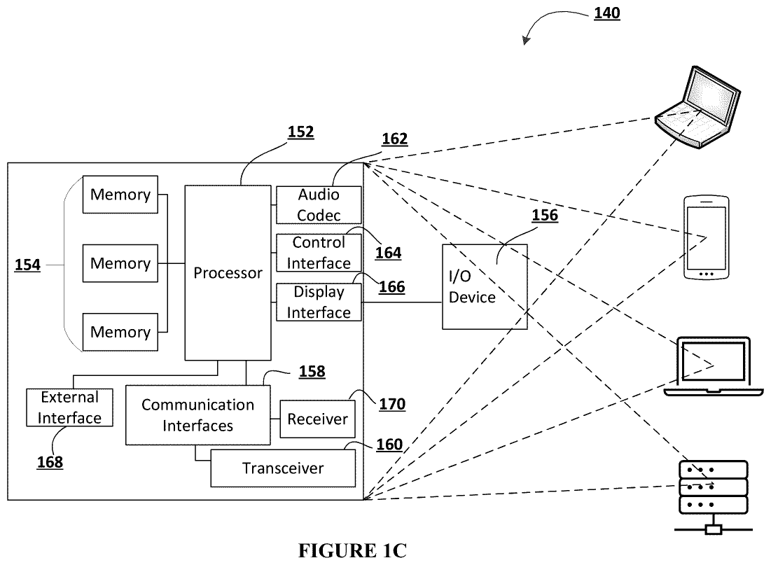

FIGS. 1A-1C illustrate technical components of an example distributed computing environment 100 for dynamic task management across a network, in accordance with various embodiments of the present disclosure. As shown in FIG. 1A, the distributed computing environment 100 contemplated herein may include a system 130 (e.g., a dynamic task management engine), an end-point device(s) 140, and a network 110 over which the system 130 and end-point device(s) 140 communicate therebetween. In various embodiments, the system 130 may be embodied by one or more of the end-point devices 140. As such, any end-point device 140 may operate as the system 130.

FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to the shared communication within the network, the distributed network often also supports distributed processing. The network 110 may be a form of digital communication network such as a telecommunication network, a local area network (“LAN”), a wide area network (“WAN”), a global area network (“GAN”), the Internet, a satellite network, a cellular network, and/or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be for example only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an example component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 (shown as “HS Interface”) connecting to the memory 104, and a low-speed interface 112 (shown as “LS Interface”) connecting to low speed expansion port 114 (Shown as “LS Port”) and storage device 106. Each of the components 102, 104, 106, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-readable or machine-readable storage medium, such as the memory 104, the storage device 106, or memory on processor 102.

The high-speed interface 108 manages bandwidth-intensive operations for the system 130, while the low speed interface 112 manages lower bandwidth-intensive operations. Such allocation of functions is for example only. In some embodiments, the high-speed interface 108 is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an example component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

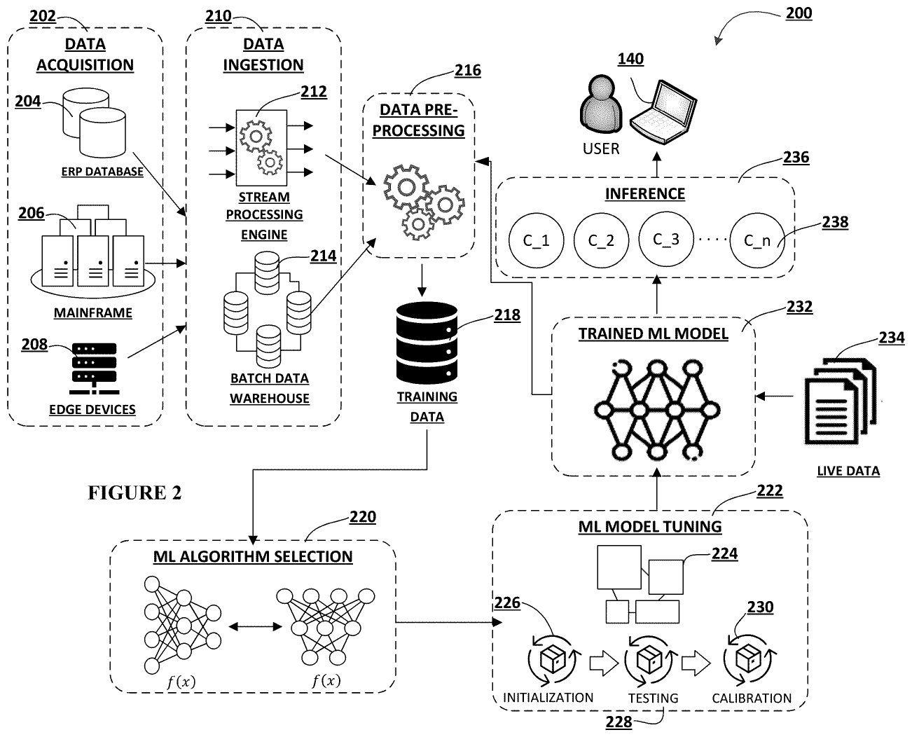

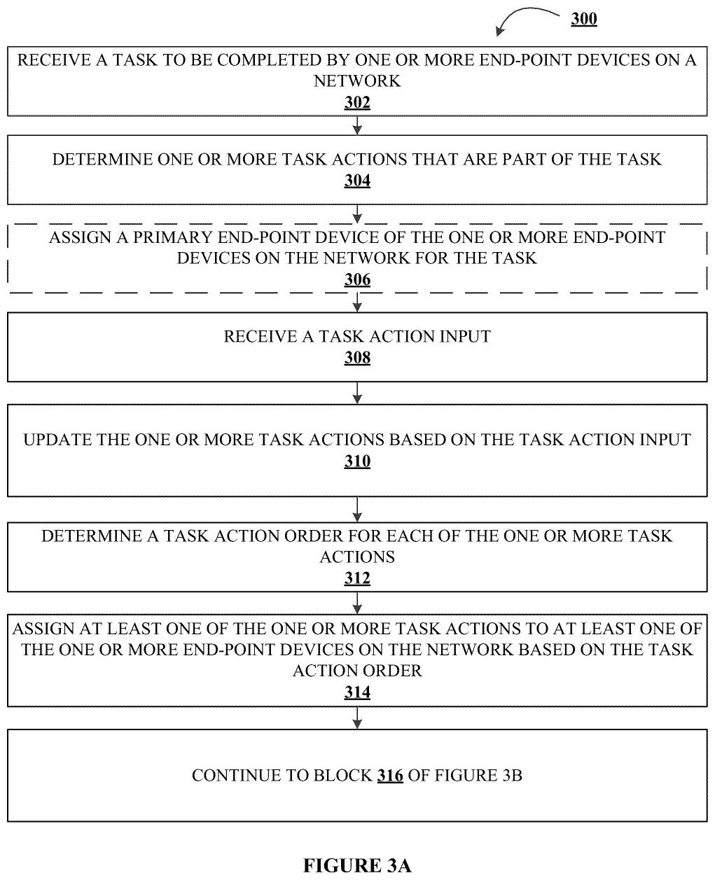

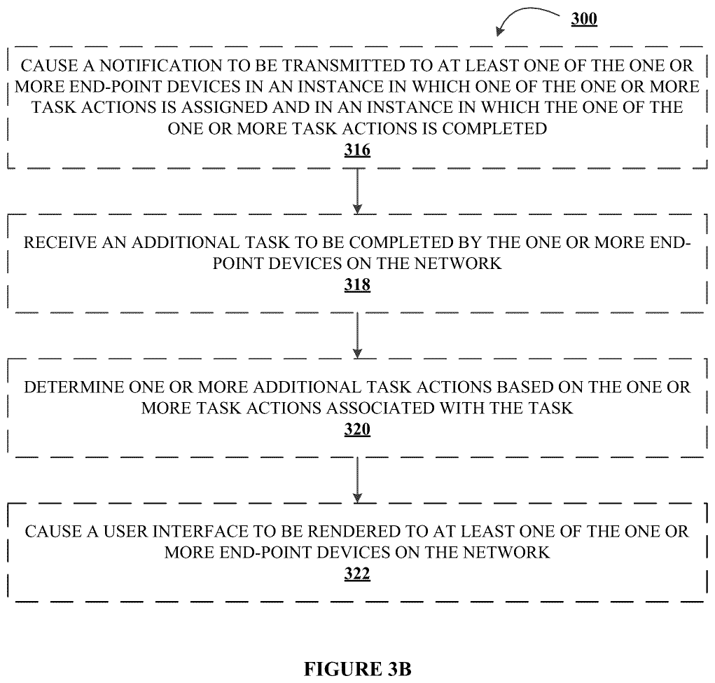

FIG. 2 illustrates an example machine learning (ML) architecture 200, in accordance with an embodiment of the present disclosure. The ML subsystem architecture may be part of the components of the environment 100 (e.g., end-point device(s) 140). The ML subsystem architecture is used to determine task actions and assignments as discussed below in reference to FIG. 3. Namely, the ML subsystem architecture may be used to train the system to determine the similarities between tasks to determine task actions for a given tasks based on previous tasks.

The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is example and that other embodiments may vary. As another example, in some embodiments, the machine learning subsystem 200 may include more, fewer, or different components.

FIGS. 3A and 3B illustrate a process flow 300 for dynamic task management across a network, in accordance with various embodiments of the present disclosure. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. Additionally, ML/AI may also be used, such the AI/ML discussed in reference to FIG. 2. Namely, the task actions discussed herein may be weighted differently to determine task action assignments.

In various embodiments, one or more of the end-point devices 140 associated with the network may be capable of executing one or more features of the process flow discussed herein. As such, each of the one or more of the end-point devices 140 associated with the network may include hardware to carry out the operations herein. Additionally, as discussed herein, various software programs and/or applications may be installed on a given end-point device to conduct the operations discussed herein.

Referring now to Block 302 of FIG. 3A, the method includes receiving a task to be completed by one or more end-point devices on a network. The task may be an operational process that is defined, automated, enhanced, and/or otherwise managed via a workflow automation platform as discussed herein. A task may be automatically generated (e.g., a task may be generated upon completion of a task) and/or manually generated (e.g., a user may input a task to be completed associated with the network).

In various embodiments, metadata relating to the task may also be received with the task. The metadata relating to the task may be produced during the generation of the task. As such, the metadata may be used to determine information relating to the task (e.g., task actions as discussed herein). The metadata may include the task action(s) to complete the task, similar tasks (e.g., previous tasks that have the same or similar task actions), difficulty and/or number of task actions for a task to be completed, and/or the like. The metadata may also indicate user roles within a task. Such user roles may include the task administrator, users that may complete task actions, and/or the like.

In various embodiments, the task may be completed by one or more users on a network. As such, each user may be associated with one or more end-point devices. As such, the task may be completed by multiple users on the network. As discussed herein, the task may be split into task actions that may be individually assigned to one or more end-point devices on a network, such that the user associated with the given end-point device that is assigned the given task action can complete the task action. In various embodiments, a user may be associated with an end-point device via logging into an account on the end-point device.

Referring now to Block 304 of FIG. 3A, the method includes determining one or more task actions that are part of the task. The task actions may be determined based on the configuration of the given task. The configuration may be determined based on the metadata provided relating to the given task. For example, the metadata may indicate one or more task actions to be carried out during execution of the task. As such, tasks may be identified as a simple task based on the number of task actions that may be carried out in order to complete the given task. A simple task may be implemented and/or modified as discussed herein.

Additionally or alternatively, the task actions may be determined based on one or more previous tasks. A task action may be any action that is part of the process of completing a task. A task action may be any subpart of a task. As such, the task action may be any step to be completed in order to complete a task. For example, in an instance in which the task is to update coding for a program, task action for the task may include generating the code, testing the code, updating devices that use the code, approving the code for implementation, and/or the like. As such, each task action may be part of the collective task.

In various embodiments, the workflow automation platform may be used for multiple tasks to be generated, revised, and completed. As such, task actions may be generated for each task. The task actions for a task may be based on one or more previous tasks. For example, the task actions may be selected based on one or more commonalities between the task and one or more of the previous tasks. A commonality may be based on the type of task (e.g., similar task types often have similar task actions and/or steps), the primary end-point device of the task (e.g., a given user may have the same task actions for each task created by the user), related task (e.g., a specific task may always follow another kind of task and the task actions may be the same each time), and/or the like.

Each task action may be completed by one of the one or more end-point devices on the network. For example, users on a network (e.g., users on a software team) may have the task action(s) distributed across the team to complete the task.

Referring now to optional Block 306 of FIG. 3A, the method includes assigning a primary end-point device of the one or more end-point devices on the network for the task. The primary end-point device may be the administrator of the given task. The primary end-point device may determine one or more task action, assignments of the task actions, and/or the like. As such, the primary end-point device may have control over various aspects of the task completion. In various embodiments, a plurality of end-point devices may be designated as a primary end-point device for a given task. Alternatively, a given task may have a single primary end-point device.

In various embodiments, the primary end-point device is capable of providing a task action input as discussed below in reference to Block 308. As such, the primary end-point device for a task may modify or otherwise change task actions relating to the task.

In various embodiments, the user interface (e.g., discussed in reference to Block 322 below) rendered to an end-point device, as discussed herein, may include each task for which the given end-point device is designated as the primary end-point device. in various embodiments, the user interface may have a primary designation portion of user interface and task action portion of the user interface. The primary designation portion may indicate any tasks for which the end-point device is designated as a primary end-point device. the task action portion of the user interface may include information relating to any task actions assigned to the end-point device.

Referring now to Block 308 of FIG. 3A, the method includes receiving a task action input. In various embodiments, the task action input may indicate a change to at least one of the one or more task actions and/or an additional task action to be added to the one or more task actions. The task action input may be any change to the task, such as a change to task parameters, a change to task action parameters, a change to task action assignments, and/or the like.

In various embodiments, the task action input may include information relating to the task action order. For example, the task action input may indicate that one of the task actions need to be started and/or completed before another task action is assigned to an end-point device.

Referring now to Block 310 of FIG. 3A, the method includes updating the one or more task actions based on the task action input. Updating the one or more task actions may include modifying an existing task action (e.g., changing a parameter of one of the task actions determined in reference to Block 304 above) and/or creating new task actions (e.g., either to replace an existing task action or be completed in addition to the existing task action(s).

A modification to the task action may include any changes to the task action, such as a change to the task assignment, a change to the task parameters (e.g., change in deadline, change in task action requirements, change in task action assignments), and/or the like. In various embodiments, new task actions may replace task actions (e.g., one or more task actions may be replaced with the new task actions). Additionally or alternatively, new task actions may be distinct from the existing task actions (e.g., the new task action may be an additional task action that was not previously included in the task actions).

Referring now to Block 312 of FIG. 3A, the method includes determining a task action order for each of the one or more task actions. In various embodiments, the system may determine whether any task actions must be started and/or completed in order to begin task. As such, a task action may have one or more prerequisite task actions that need to be started and/or completed before the given task action may be completed. As such, the task action order may be a hierarchy of task actions to be completed.

In various embodiments, the task action order may indicate task actions that take priority over other task actions. For example, one or more required task action(s) may be required for a task to be completed, while one or more secondary task actions(s) may not be necessary to complete a task (e.g., a primary task action may be related to a software operation, while a secondary task action may relate to interface formatting). As such, the system may determine a plurality of task action tiers in the task action order (e.g., a required task action tier, a second task action tier, etc.)

In various embodiments, the task action order may include a sequence for one or more of the task actions. For example, a first task action may be completed before a second task action is completed and a third task action is not started until the second task action is completed.

Referring now to Block 314 of FIG. 3A, the method includes assigning at least one of the one or more task actions to at least one of the one or more end-point devices on the network based on the task action order. One or more end-point devices may be assigned one or more task actions. In various embodiments, each of one or more end-point devices may be assigned a predetermined number of task actions at a time. For example, an end-point device may be assigned one task action, two task actions, three task actions, etc.

In various embodiments, the assignment of the at least one of the one or more task actions comprises determining a task permission for each of the at least one of the one or more task actions. A task permission for an end-point device may indicate how much a user associated with the given end-point device can customize a task action and/or the task at large. For example, a first permission level may only let a user complete the task action (e.g., read-only permission), a second permission level may allow a user to customize a task action assigned to the user, a third permission level may allow a user to customize the task actions and/or other task actions not assigned to the user, a fourth permission level in which the user is assigned as the primary end-point device (e.g., a primary end-point device may be able to customize any part of the task, such as by providing a task action input).

In various embodiments, the system may also be configured to determine an assignment for one of the one or more end-point devices based upon one of the one or more task actions completed by the given end-point device. As such, in an instance in which a user associated with an end-point device completes a task action, the system may determine one or more task actions to assign to the end-point device.

In various embodiments, the assignment of a task action may be based on the capabilities of a user (e.g., a user associated with an end-point device). Examples of capabilities include the user availability (e.g., based on other tasks assigned and/or working hours of the user), the user experience (e.g., types of software), and/or the like.

Referring now to optional Block 316 of FIG. 3B, the method includes causing a notification to be transmitted to at least one of the one or more end-point devices in an instance in which one of the one or more task actions is assigned and in an instance in which the one of the one or more task actions is completed.

The notification may be displayed on the user interface discussed herein (e.g., the notification may be rendered to the user interface generated for the end-point device). Additionally or alternatively, the notification may be provided via various other communication methods (e.g., electronic mail, text messages, telephone calls, and/or the like).

The notification may indicate the status of a task action and/or the task as a whole (e.g., the number of task actions completed). For example, the notification may include that a task action was completed and/or the number of total task actions that are completed. Additionally or alternatively, the notification may indicate assignments of task actions. For example, the notification may indicate new assignments (e.g., either related to completing to task action(s) or upon initial assignment).

Referring now to optional Block 318 of FIG. 3B, the method includes receiving an additional task to be completed by the one or more end-point devices on the network. In various embodiments, the additional task may be received just as the task is received in Block 302 discussed herein. For example, the task may be an operational process that is defined, automated, enhanced, and/or otherwise managed via a workflow automation platform as discussed herein.

Referring now to optional Block 320 of FIG. 3B, the method includes determining one or more additional task actions based on the one or more task actions associated with the task. The additional task action may be determined just as the task actions were determined for the task in Block 304 discussed above. Additionally, the additional task action may be based in part on the task actions of the task. For example, in an instance in which the task has one or more commonalities with the additional tasks, the task actions of the task may be used to determine the additional task actions.

Referring now to optional Block 322 of FIG. 3B, the method includes causing a user interface to be rendered to at least one of the one or more end-point devices on the network. In various embodiments, the user interface may be customized for individual end-point devices. For example, each end-point device may be rendered information relating to the task actions assigned to the given end-point device and/or any tasks in which the end-point device is designated as the primary end-point device.

In various embodiments, the user interface includes each of the task actions assigned to the given end-point device. The user interface may include various information relating to the task action, such as the timeline (e.g., date assigned, date due to be completed, etc.), task action details (e.g., parameters of the task action), task information (e.g., status of the task, primary end-point device, etc.), and/or the like.

In various embodiments, the user interface rendered to at least one of the one or more end-point devices includes a plurality of assigned task actions assigned to the given end-point device. For example, as discussed above, the user interface may include a primary designation portion and/or a assigned task portion. In various embodiments, the plurality of assigned task actions includes at least one of the one or more task actions associated with the task and at least one additional task action associated with one or more additional tasks.

In various embodiments, the user interface includes at least one of the one or more task actions and at least one of the one or more additional task actions assigned to the given endpoint device.

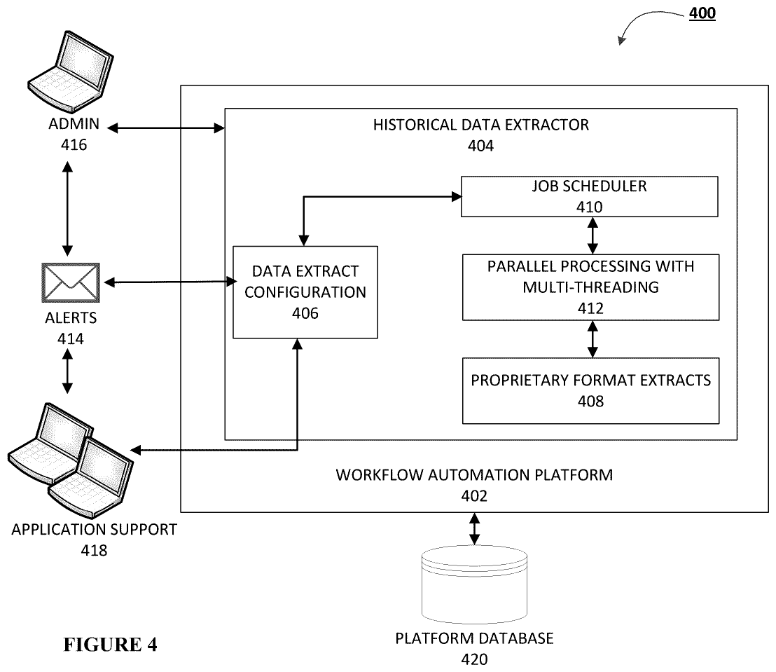

FIG. 4 illustrates a process flow 400 for extraction of historical data in workflow automation platform architectures, in accordance with an embodiment of the disclosure. At the core of process flow 400 in FIG. 4 lies the workflow automation platform 402, a system component designed to streamline and manage various internal processes of an entity. This platform serves as the primary repository for all process-related activities, and importantly, it holds historical data essential for analytical insights. The intrinsic architecture of this platform ensures that data is stored efficiently, albeit in proprietary formats that might pose challenges for traditional extraction methods.

The historical data extractor 404 embedded within the workflow automation platform 402 emerges as a solution to the aforementioned extraction challenges. It is designed with several integral components to enable seamless data extraction and transformation. At its foundation is the data extract configuration 406, which generates and transmits a user-friendly interface, allowing administrators to define specific parameters for data extraction such as time ranges, data types, and extraction frequencies. This component ensures that only relevant data is affected, optimizing the extraction process.

Once data extraction parameters are set, the job scheduler 410 may be utilized. Functioning as the orchestration center for historical data extraction from the workflow automation platform 402, it determines the sequence and prioritization of extraction tasks. Taking into account the volume and complexity of data extracts, the job scheduler allocates tasks to specific threads or processors, leveraging the parallel processing multi-threading 412 engine. The parallel processing multi-threading 412 engine mechanism ensures that multiple data extraction tasks can occur simultaneously, leading to a substantial increase in extraction efficiency.

In some embodiments, given that the data in the workflow automation platform 402 may be originally stored in proprietary formats, the proprietary format extracts 408 are shown downstream of the parallel processing with multi-threading 412. In some embodiments, a specific system module specializes in deciphering and converting the native data formats into more universally accessible and normalized datasets. In some embodiments, transformation is critical, ensuring that the extracted data is readily consumable by external reporting and analytical tools.

To support and oversee the process 400, auxiliary components like the admin device 416, alerts 414, and application support devices 418 are incorporated. the admin device 416 provides a control center for administrators, granting them an overview and control of the entire extraction process. Simultaneously, alerts 414 may be sent via the data extract configuration 406 as to proactively notify admin 416 or application support 418 of any issues or successful completions. The extracted data, once processed, is then stored or further utilized through connections with platform database 420, which serves as a structured repository or a bridge to other systems, ensuring that the invaluable historical insights are securely housed and ready for analysis.

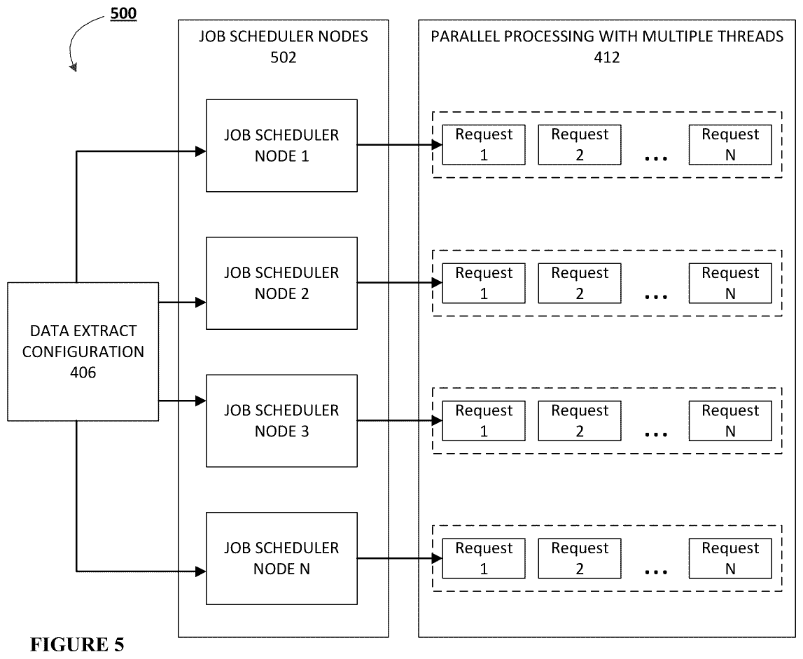

FIG. 5 illustrates a process flow 500 for parallel processing data extraction of historical data in workflow automation platform architectures, in accordance with an embodiment of the disclosure. Various operations of FIGS. 3A, 3B, 4, and 5 may be carried out by the same system, unless otherwise stated. Namely, the job scheduler discussed in reference to FIG. 5 may be used to assign tasks to end-point devices as discussed in reference to FIGS. 3A and 3B.

Central to process flow 500 is the data extract configuration 406. Acting as the blueprint of the extraction process, it communicates specific extraction parameters and instructions to the multiple job scheduler nodes 502 shown in FIG. 5. These instructions can include details on the kind of data to be extracted, the timeframe for which the data is required, and the desired format of the output, or the like. Upon receiving these instructions, each Job Scheduler Node, from Node 1 to Node N, proceeds to generate a set of requests tailored to the configuration's specifications. These requests can be understood as individual tasks or data queries. Given the distributed nature of the system, multiple nodes can work independently and concurrently, breaking down the larger extraction goal into more manageable, smaller tasks.

For instance, in some embodiments, job scheduler node 1 generates a sequence of requests: Request 1, Request 2, through to Request N. In some embodiments, each of these requests might be responsible for extracting a specific subset of data or querying a particular database segment. This pattern is mirrored across job scheduler nodes 2, 3, and all the way up to node N. The modular nature of this system allows for the efficient distribution of tasks and ensures that no two nodes replicate the work of another, creating maximum efficiency and reduced redundancy. Encapsulating all these extraction requests is the parallel processing multi-threading 412 component. This component ensures that multiple requests from various scheduler nodes can be executed simultaneously, in parallel. The parallel processing multi-threading 412 does so by allocating each request to a separate thread or processor. By facilitating simultaneous data extraction, this mechanism significantly reduces the time required to extract vast amounts of data, ensuring the solution's efficacy and efficiency. The parallel processing multi-threading 412 is a sophisticated system that leverages both software and hardware components to optimize data extraction. At the software level, it usually utilizes programming frameworks and libraries designed to facilitate concurrent processing. On the hardware side, it makes use of multi-core processors and potentially even distributed systems to run threads or tasks in parallel. Languages such as Java or C++ have built-in support for multi-threading. In some embodiments, middleware solutions may be utilized to queue tasks and distribute them across multiple processing units or nodes. It is understood that modern CPUs come with multiple cores. Each core can run a separate thread or even multiple threads simultaneously, depending on the architecture. Software-level multi-threading combined with multi-core processors can lead to genuine parallel execution. In some embodiments, the system is configured to optimize data extraction via the parallel processing multi-threading engine 412 via implementing a feedback loop from the multiple job scheduler nodes 302 to adjust thread allocation in real-time, based on system performance metrics and extraction progress.

The feedback loop, which is pivotal to the system's adaptability and efficiency, is established through continuous monitoring and data relay mechanisms. As the multiple job scheduler nodes 302 run tasks, they consistently transmit a stream of performance metrics and extraction progress updates. These metrics might include CPU usage, memory consumption, thread wait times, and any encountered bottlenecks. The feedback loop captures these metrics and routes them to the parallel processing multi-threading engine 412. This engine, using sophisticated algorithms, analyzes the incoming data to make informed decisions in real-time. If a node is underperforming or if there's an unexpected surge in data extraction requirements, the system can adjust thread allocations on-the-fly to meet the dynamic needs. This continuous adjustment ensures that the extraction process remains efficient, minimizing lags and maximizing resource utilization.

In scenarios where data volume is vast, a single machine might not suffice. Systems like cluster computers or cloud computing resources can be harnessed in some embodiments. Distributed systems break down tasks and distribute them across nodes in the cluster, achieving parallelism at a larger scale. To ensure equal distribution of requests and avoid overloading a particular thread or node, load balancers can be integrated in some embodiments. In order that the system is able to track how threads and processes are performing and ensure system health, monitoring tools can be employed in some embodiments. In some embodiments, these tools provide real-time insights and alerts on system performance, ensuring optimal functioning.

In some embodiments, the system is further configured to monitor a status and completion percentage of each of the multiple job scheduler nodes and corresponding data requests in real-time. The system boasts an intricate real-time monitoring mechanism purpose-built to monitor the status and completion percentage of each of the multiple job scheduler nodes as well as their corresponding data requests. This monitoring is more than a mere status check; it is an intelligent, dynamic process that aims to ensure the highest levels of efficiency and reliability throughout the data extraction phase. At the core of this mechanism is a comprehensive dashboard, often accessible through the system's user interface, which provides visualizations, metrics, and logs that administrators and other authorized users can review.

To achieve this real-time monitoring, each job scheduler node is equipped with telemetry and logging capabilities. As these nodes execute their tasks, they continuously transmit a stream of data that encapsulates their current status, errors or exceptions encountered, and the progress percentage of the data requests they're handling. This data is sent to a centralized monitoring module, which then processes and analyzes the information.

For instance, if a node experiences a bottleneck or a delay, the system can detect this deviation in real-time. Based on predefined thresholds and algorithms, the monitoring module can raise alerts or even automatically re-allocate resources to ensure that the affected data requests are processed without significant delays. Moreover, the real-time status updates empower administrators to make informed decisions. If they notice a node consistently underperforming, they could delve deeper to diagnose the issue or route tasks to other more efficient nodes temporarily. This real-time insight into the workflow ensures that the system maintains its ideal level of efficiency.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for dynamic task management across a network, the system comprising:
at least one non-transitory storage device containing instructions; and
at least one processing device coupled to the at least one non-transitory storage device, wherein the at least one processing device, upon execution of the instructions, is configured to:
receive a task to be completed by one or more end-point devices on a network, wherein the task comprises metadata relating to the task;
determine one or more task actions that are part of the task based on the metadata relating to the task, wherein each of the one or more task actions are completed by one of the one or more end-point devices on the network;
receive a task action input, wherein the task action input indicates a change to at least one of the one or more task actions or indicates an additional task action to be added to the one or more task actions;
update the one or more task actions based on the task action input;
determine a task action order for each of the one or more task actions, wherein the task action order indicates one or more of the task actions that must be completed before a given task action order can be started; and
assign at least one of the one or more task actions to at least one of the one or more end-point devices on the network based on the task action order.

2. The system of claim 1, wherein the at least one processing device, upon execution of the instructions, is configured to cause a user interface to be rendered to at least one of the one or more end-point devices on the network, wherein the user interface comprises each of the task actions assigned to the given end-point device.

3. The system of claim 2, wherein the user interface rendered to at least one of the one or more end-point devices comprises a plurality of assigned task actions assigned to the given end-point device, wherein the plurality of assigned task actions comprises at least one of the one or more task actions associated with the task and at least one additional task action associated with one or more additional tasks.

4. The system of claim 1, wherein the at least one processing device, upon execution of the instructions, is configured to:
receive an additional task to be completed by the one or more end-point devices on the network; and
determine one or more additional task actions based on the one or more task actions associated with the task.

5. The system of claim 4, wherein the at least one processing device, upon execution of the instructions, is configured to cause a user interface to be rendered to at least one of the one or more end-point devices on the network, wherein the user interface comprises at least one of the one or more task actions and at least one of the one or more additional task actions assigned to the given end-point device.

6. The system of claim 1, wherein the assignment of the at least one of the one or more task actions comprises determining a task permission for each of the at least one of the one or more task actions.

7. The system of claim 1, wherein the at least one processing device, upon execution of the instructions, is configured to assign a primary end-point device of the one or more end-point devices on the network for the task, wherein the primary end-point device is capable of providing a task action input.

8. The system of claim 1, wherein the at least one processing device, upon execution of the instructions, is configured to cause a notification to be transmitted to at least one of the one or more end-point devices in an instance in which one of the one or more task actions is assigned and in an instance in which the one of the one or more task actions is completed.

9. The system of claim 1, wherein the at least one processing device, upon execution of the instructions, is configured to determine an assignment for one of the one or more end-point devices based upon one of the one or more task actions completed by the given end-point device.

10. A computer program product for dynamic task management across a network, the computer program product comprising at least one non-transitory computer-readable medium having computer-readable program code portions embodied therein, the computer-readable program code portions comprising one or more executable portions configured to:
receive a task to be completed by one or more end-point devices on a network, wherein the task comprises metadata relating to the task;
determine one or more task actions that are part of the task based on the metadata relating to the task, wherein each of the one or more task actions are completed by one of the one or more end-point devices on the network;
receive a task action input, wherein the task action input indicates a change to at least one of the one or more task actions or indicates an additional task action to be added to the one or more task actions;
update the one or more task actions based on the task action input;
determine a task action order for each of the one or more task actions, wherein the task action order indicates one or more of the task actions that must be completed before a given task action order can be started; and
assign at least one of the one or more task actions to at least one of the one or more end-point devices on the network based on the task action order.

11. The computer program product of claim 10, wherein the computer-readable program code portions comprising one or more executable portions are also configured to:
cause a user interface to be rendered to at least one of the one or more end-point devices on the network,
wherein the user interface comprises each of the task actions assigned to the given end-point device,
wherein the user interface rendered to at least one of the one or more end-point devices comprises a plurality of assigned task actions assigned to the given end-point device, and wherein the plurality of assigned task actions comprises at least one of the one or more task actions associated with the task and at least one additional task action associated with one or more additional tasks.

12. The computer program product of claim 10, wherein the computer-readable program code portions comprising one or more executable portions are also configured to:
receive an additional task to be completed by the one or more end-point devices on the network;
determine one or more additional task actions based on the one or more task actions associated with the task; and
cause a user interface to be rendered to at least one of the one or more end-point devices on the network, wherein the user interface comprises at least one of the one or more task actions and at least one of the one or more additional task actions assigned to the given end-point device.

13. The computer program product of claim 10, wherein the assignment of the at least one of the one or more task actions comprises determining a task permission for each of the at least one of the one or more task actions.

14. The computer program product of claim 10, wherein the computer-readable program code portions comprising one or more executable portions are also configured to assign a primary end-point device of the one or more end-point devices on the network, wherein the primary end-point device is capable of providing a task action input.

15. The computer program product of claim 10, wherein the computer-readable program code portions comprising one or more executable portions are also configured to cause a notification to be transmitted to at least one of the one or more end-point devices in an instance in which one of the one or more task actions is assigned and in an instance in which the one of the one or more task actions is completed.

16. A method for dynamic task management across a network, the method comprising:
receiving a task to be completed by one or more end-point devices on a network, wherein the task comprises metadata relating to the task;
determining one or more task actions that are part of the task based on the metadata relating to the task, wherein each of the one or more task actions are completed by one of the one or more end-point devices on the network;
receiving a task action input, wherein the task action input indicates a change to at least one of the one or more task actions or indicates an additional task action to be added to the one or more task actions;
updating the one or more task actions based on the task action input;
determining a task action order for each of the one or more task actions, wherein the task action order indicates one or more of the task actions that must be completed before a given task action order can be started; and
assigning at least one of the one or more task actions to at least one of the one or more end-point devices on the network based on the task action order.

17. The method of claim 16, further comprising:
causing a user interface to be rendered to at least one of the one or more end-point devices on the network,
wherein the user interface comprises each of the task actions assigned to the given end-point device,
wherein the user interface rendered to at least one of the one or more end-point devices comprises a plurality of assigned task actions assigned to the given end-point device, and
wherein the plurality of assigned task actions comprises at least one of the one or more task actions associated with the task and at least one additional task action associated with one or more additional tasks.

18. The method of claim 16, further comprising:
receiving an additional task to be completed by the one or more end-point devices on the network;
determining one or more additional task actions based on the one or more task actions associated with the task; and
causing a user interface to be rendered to at least one of the one or more end-point devices on the network, wherein the user interface comprises at least one of the one or more task actions and at least one of the one or more additional task actions assigned to the given end-point device.

19. The method of claim 16, further comprising assigning a primary end-point device of the one or more end-point devices on the network, wherein the primary end-point device is capable of providing a task action input.

20. The method of claim 16, further comprising causing a notification to be transmitted to at least one of the one or more end-point devices in an instance in which one of the one or more task actions is assigned and in an instance in which the one of the one or more task actions is completed.
